(19) United States
(12) Patent Application Publication
(10) Pub. No.: US 2012/0185359 A1
(43) Pub. Date: Jul. 19, 2012

(54) RANKING OF QUERY RESULTS BASED ON INDIVIDUALS' NEEDS

(75) Inventors: Chao Chen, Hangzhou (CN); Xiaomei Han, Hangzhou (CN)

(73) Assignee: ALIBABA GROUP HOLDING LIMITED, George Town (KY)

(21) Appl. No.: 13/348,446

(22) Filed: Jan. 11, 2012

(30) Foreign Application Priority Data
Jan. 14, 2011 (CN) 201110007847.9

(51) Int. Cl. G06Q 30/06

(52) U.S. Cl. 705/26.63

(57) ABSTRACT

Providing query results includes: receiving a search query sent by a user; obtain user information that corresponds to the user; determining, at an online transaction system, merchandise information that corresponds to the search query; based on correspondence information of previously stored user information and previously stored search queries with respective highest need level categories, determining a highest need level category that correspond to the received user information and obtained search query, wherein the highest need level category is a category determined to best reflect the user's individual need for merchandise information in response to the search query; and ranking the merchandise information at least in part according to the determined highest need level category.

### CROSS REFERENCE TO OTHER APPLICATIONS

This application claims priority to People's Republic of China Patent Application No. 201110007847.9 entitled METHOD AND DEVICE FOR RANKING SEARCH RESULTS filed Jan. 14, 2011 which is incorporated herein by reference for all purposes.

### FIELD OF THE INVENTION

The present application relates to the field of data processing. In particular, it relates to ranking search results.

### BACKGROUND OF THE INVENTION

Existing ranking techniques by current online transaction systems are typically based on text correlation and market mechanisms, i.e., rankings are influenced by textual correlation of information and business factors. For example, information quality and supplier factors can be used to affect rankings

The core of such a technique is to rank on the basis of the textual correlation and business factors of the query results. Its drawback is that all users receive the same results for the same query word; the ranking results may not meet the individual buyer's needs very well. This is because the ranking results generated by such a ranking method primarily take into account textual correlation and other business factors without differentiating between how each piece of information meets the needs of individual users. The personalized needs of some users thus cannot be met, resulting in poor buying experiences.

The ranking results generated by such a method often results in rather low click-through rates for query results. As used herein, the query result click-through rate is the total click traffic (e.g., the number of clicks) divided by the total exposure (e.g., the total number of times a result is shown). When the buyer's need is not met by the query results, click-through rates fall, thereby causing the online transaction system to have lower traffic quality and lower click-through rates.

In addition, such a method typically does not differentiate merchandise information. Usually, each time the server responds to a user query from a client, it transmits to the client all the merchandise information mixed together without differentiation. Data transmission volumes in the network consequently increase, and response speeds decrease. Moreover, the user will often see a large volume of merchandise information that does not match his or her actual needs, since merchandise information that is well-matched with the user's needs is mixed together with merchandise information that is poorly-matched with the user's needs. As a result, the user may make many selections that do not actually match his or her needs, causing the client to send large volumes of useless query requests to the server, adding to operating pressures on the server and further diminishing the response speed of the server.

Moreover, such a technique is often detrimental to the effective allocation of market resources. With the use of such a method, click-through rates drop as buyer need types fail to match merchandise information. Consequently, some sellers whose products are in high demand lose opportunities to be displayed, thus hindering advances in market efficiency.

### BRIEF DESCRIPTION OF THE DRAWINGS

Various embodiments of the invention are disclosed in the following detailed description and the accompanying drawings.

FIG. 1 is a system diagram illustrating an embodiment of an online transaction system.

FIG. 2 is a flowchart illustrating an embodiment of a merchandise information ranking process.

FIG. 3 is a flowchart illustrating an embodiment of a process for obtaining correspondences between user information and search queries, and respective highest need level categories.

FIG. 4 is a flowchart illustrating another embodiment of a merchandise information ranking process.

FIG. 5 is a flowchart illustrating an embodiment of a process for obtaining category grading information and attribute grading information.

FIG. 6 is a flow chart illustrating another embodiment of a merchandise information ranking process.

FIG. 7 is a system diagram illustrating a first embodiment of a search results ranking device of the present application.

FIG. 8 is a structural diagram illustrating an embodiment of the second preprocessing module 14 in FIG. 7.

FIG. 9 is a structural diagram illustrating another embodiment of a search results ranking device of the present application.

FIG. 10 is a structural diagram illustrating an embodiment of the second preprocessing module in FIG. 9.

FIG. 11 is a structural diagram of another embodiment of a search results ranking device of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Ranking of merchandise information in response to user queries based on the highest need level categories is disclosed. As used herein, the highest need level category refers to the category of merchandise information that is determined (e.g., by computation based on existing data and formulas) to most closely reflects a user's individual need for information in making the query. Based on a log corresponding to user information, the highest need level categories corresponding to user information and search queries are obtained, as well as the correspondences mapping between user information and search queries on the one hand and respective highest need level categories on the other.

Using the correspondences of user information and search queries with respective highest need level categories, it is possible to obtain the highest need level category corresponding to a user when he or she enters a search query, and rank merchandise information in accordance with the highest need level category with the merchandise information corresponding to the highest need level category being ranked higher. The traffic quality of the online transaction system and raising click-through rates are thus improved. Moreover, since the merchandise information can embody the user's personalized needs, the user need not send large volumes of useless query requests through the client end to the server. As a result, this scheme reduces operating pressures on the server and increases server response speed.

The present application also offers a search results ranking method, wherein merchandise information is ranked in response to user query requests by using the aforesaid highest need level categories corresponding to user information.

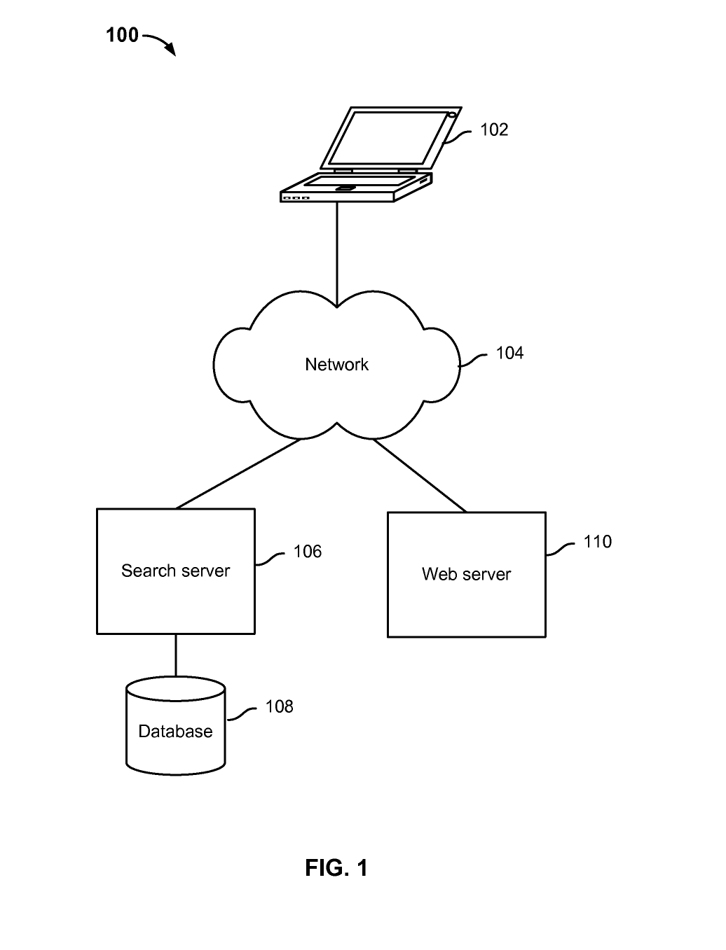

FIG. 1 is a system diagram illustrating an embodiment of an online transaction system. System 100 includes client device 102, network 104, search server 106, database 108, and web server 110. In some embodiments, network 104 is implemented using high-speed data networks and/or telecommunications networks. In some embodiments, search server 106 and web server 110 are configured to work separately but coordinate with each other. In some embodiments, search server 106 and web server 110 are configured to work in combination and may be implemented using the same machine or the same set of machines. In some embodiments, web server 110 supports a website and/or a search engine.

Examples of client device 102 include a laptop computer, a desktop computer, a smart phone, a mobile device, a tablet device or any other computing device. Client device 102 is configured to communicate with search server 106. In various embodiments, an application such as a web-browser is installed at client device 102 to enable communication with search server 106. For example, a user at client device 102 can access a website associated with/hosted by web server 110 by entering a certain uniform resource locator (URL) at the web browser address bar. For example, web server 110 can be associated with an electronic commerce website. A user can submit a search query that includes one or more search keywords at client device 102 to search server 106. In some embodiments, search server 106 can store log information regarding various users' searching histories. For example, search server 106 can store log information (e.g., in database 108) such as search queries, user information of the users who entered the search queries, whether they clicked on any of the search results returned, and which search results were selected. In some embodiments, search server 106 is configured to use the log information to determine the highest need categories that correspond to the search queries and user information, and store the corresponding relationships of search queries and user information on the one hand, and highest need categories on the other. As will be discussed in further detail below, search server 106 is configured to use the stored corresponding relationships to determine the highest need category for a given search query entered by a user, and rank merchandise information based at least in part on the highest need category. The ranked merchandise information is returned to the client by the search server directly or via the webserver. Based on the ranking, more relevant merchandise information is displayed first on client device 102.

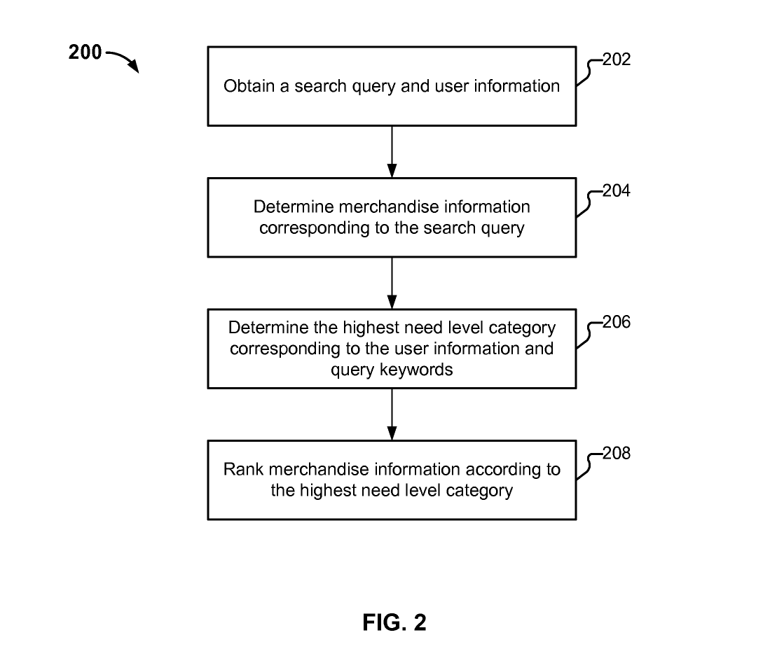

FIG. 2 is a flowchart illustrating an embodiment of a merchandise information ranking process. Process 200 may be performed on an online transaction system such as 100 of FIG. 1.

At 202, a search query (which may include one or more query words) and user information are received. The search query can be input by the user via the client device, and the user information can be acquired by the online transaction system from pre-stored user account/registration information.

At 204, merchandise information corresponding to the search query is determined.

At 206, based on pre-stored correspondence of logged user information and logged search queries with respective highest need level categories, the highest need level category corresponding to the received user information and search query is determined.

At 208, merchandise information according to the highest need level category is ranked.

In some embodiments, the search results can include multiple pieces of merchandise information. Process 200 ranks merchandise information according to the obtained highest need level category that corresponds to the user information. Thus, merchandise information conveys the personalized needs of users, and the merchandise information corresponding to the highest need level category is ranked higher. As a result, the user can quickly find merchandise information that satisfies his or her needs. This in turn can improve the quality of online transaction system traffic, increase click-through rates, and enhance the user's experience. In addition, because the merchandise information conveys users' personalized needs, the user need not send large volumes of useless query requests through the client end to the server. As a result, this scheme reduces operating pressures on the server and increases server response speed. In addition, such a ranking technique helps with the effective allocation of market resources. It can provide sellers whose products are in high demand with more opportunities to display relevant information, thus raising click-through rates.

In some embodiments, prior to process 200, correspondences of previously stored user information and previously stored search queries with respective highest need level categories are obtained. Specifically, correspondences between user information and search queries and respective highest need level categories are obtained based on logs of user information and search queries. Categories are used to describe classifications of merchandise information. Every piece of merchandise information has a classification that corresponds to it. For example, merchandise information concerning mobile phones is placed under the mobile phone category.

The correspondences between user information and search queries with respective highest need level categories may be predetermined (e.g., executed offline) and does not have to be carried out during the merchandise transaction. Thus, after obtaining the search queries and user information, the online transaction system can directly search for the highest need level corresponding to the user information and the search query and rank the merchandise information in accordance with highest need level category. Thus, there is no need to execute the step of obtaining the highest need level category for a user during the merchandise transaction process. This can increase data processing speed in the merchandise transaction process and improve the user's experience.

According to an embodiment of the present application, user information may include ID, email address, and other such information.

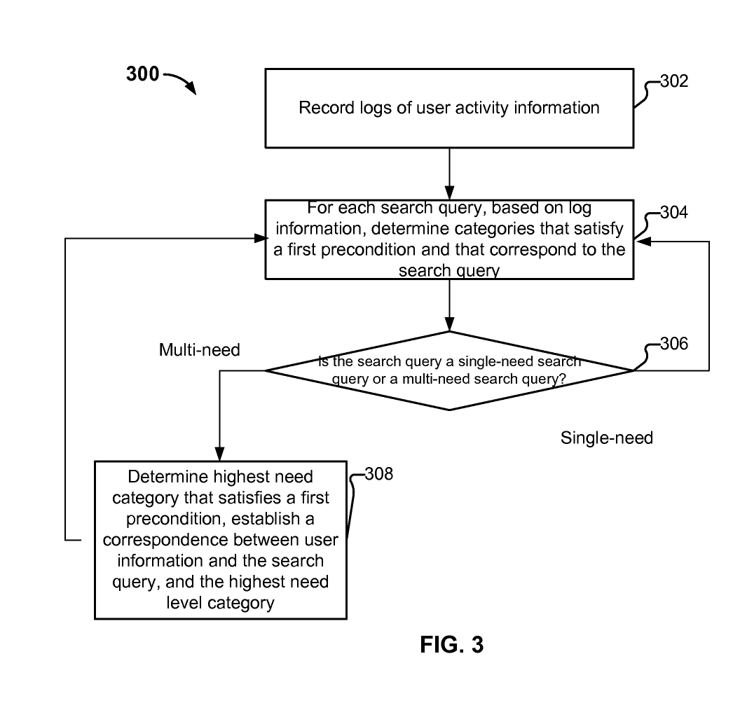

FIG. 3 is a flowchart illustrating an embodiment of a process for obtaining correspondences between user information and search queries, and respective highest need level categories. Process 300 may be performed by an online transaction system such as 100.

At 302, logs of user activity information are recorded. In some embodiments, the logs include a click log and an exposure log. The data stored in the logs includes: search queries searched by the users, category exposures, category click frequencies, merchandise information click frequencies, and merchandise information exposures by category.

At 304, based on logs corresponding to user information, for each search query in the log, categories that satisfy a first precondition and that correspond to the search query are determined. For example, the system can specifically obtain a category whose category exposure rate is greater than a preset exposure threshold value (e.g., 5%) and whose click-through rate is greater than a preset click-through rate (e.g., an average search query click-through rate of 50%). Data analysis has shown that, to a great extent, category exposure and click-through rates decide the correlation between category and search query. By measuring these two features (category exposure and click-through rate), the system can obtain categories associated with search queries. Presetting a first condition can eliminate categories obviously not associated with the search query.

At 306, for each search query in the logs, based on the category exposure of the category with the largest category exposure among categories satisfying the first precondition, it is determined whether the search query is a single-need search query or a multi-need search query.

A multi-need search query corresponds to multiple need types. In the present embodiment, categories are used to describe need types, and each need type corresponds to a category. That is, each multi-need search query corresponds to multiple categories. For example, the need types for “apple” might be fruit, electronic products, or apparel. That is, when the user inputs the search query “apple,” his or her query objective might be the fruit or it might be Apple brand electronic products or apparel. In other words, the word “apple” is a multi-need search query. A single-need search query corresponds to one need type only. That is, each single-need search query corresponds to one category. For example, “mobile phone” is a single-need search query that corresponds to the mobile phone category only.

A category satisfying a first precondition may be a category having a category exposure greater than a preset exposure threshold value (such as 5%) and a click-through rate greater than a preset click-through rate threshold (e.g., 50% of the average click-through rate for search queries).

For a single-need query, its corresponding category that has the largest exposure of all the categories satisfying a first precondition has a category exposure that is greater than a threshold value. For a multi-need query, its corresponding category that has the largest exposure of all the categories satisfying a first precondition has a category exposure that is less than or equal to a threshold value.

In step 306, for a given search query, if the category exposure of the category having the largest exposure of all the categories satisfying a first precondition is greater than a threshold value, then the search query is determined to be a single-need search query. If the category exposure of the category having the largest exposure of all the categories satisfying a first precondition is less than or equal to a threshold value, then the search query is determined to be a multi-need search query. For example, a first threshold value could be 80% of total exposure of all categories (including categories satisfying a first precondition and all categories not satisfying a first precondition) that correspond to the search query. As for single-need search queries, because they correspond to one category only, when a user inputs a single-need search query to conduct a query, the majority of the acquired query results correspond to the same category. Therefore, this category will have a larger exposure. In the case of multi-need search queries, because they correspond to multiple categories, when a user inputs a multi-need search query to conduct a query, there will be multiple categories corresponding to the acquired query results. These multiple categories would not be simultaneously displayed to the user. Therefore, the category exposure corresponding to the search query is smaller.

According to an embodiment of the present application, maximum category exposure is greater than a first threshold value in the case of single-need search queries. The highest need level category corresponding to this type of search query is the same for different users. It is therefore not necessary to obtain the highest need level category corresponding to this type of search query. Thus, if a search query is determined to be a single-need query in 306, no additional processing is needed, and step 306 is repeated for the next search query.

Maximum category exposure is less than or equal to a first threshold value in the case of multi-need search queries. The highest need level category corresponding to this type of search query is different for different users. Therefore, it is necessary to obtain the highest need level corresponding to this type of search query.

If the search query is a multi-need search query, then, at 308, its highest need level category among categories satisfying a first precondition is determined, and a correspondence between user information and the search query, and the highest need level category is established.

The search query can be differentiated between a clicked search query and an unclicked search query according to different frequencies of actions under the search query. When the user searches a clicked search query, there is a category click action or a merchandise information click action. When the user searches an unclicked search query, there is no category click action or merchandise information click action.

In step 308, depending on whether the search query is clicked or unclicked, different techniques can be employed to obtain user information and the correspondence between the highest need level category and the search query.

In the case of a clicked search query, categories satisfying a first precondition, the merchandise information click frequency (i.e., the click frequency for each piece of merchandise information corresponding to the category), and category click frequency for all categories satisfying a first precondition can be obtained from logs. Then, based on the merchandise information click frequency and category click frequency for the selected categories, the need values for all categories satisfying a first precondition are obtained, and the category having the highest need value is determined as the highest need level category. According to an embodiment of the present application, the formula for calculating the category need value is the following:

Category need value=(2*(category click frequency+merchandise information click frequency))/information exposure under category (1)

In the case of unclicked search query, the system can select the highest-frequency category from a pre-obtained category list corresponding to the user's background (e.g., the user's business or professional background, industry the user has indicated interest in during signup, etc.) and assess whether the click-through rate of the highest-frequency category satisfies a second precondition. If the click-through rate of the highest-frequency category fails to satisfy a second precondition, then the second-highest-frequency category is selected, and whether the click-through rate of the second-highest-frequency category satisfies a second precondition is assessed, and so on, until a category whose click-through rate satisfies a second precondition is found.

If, after going through all of the selected categories, the system still cannot find a category whose click-through rate satisfies a second precondition, it is then determined that the click-through rates under this search query for known categories corresponding to the user is too low and unsuitable for personalizing. That is, it is not necessary to obtain the highest need level category corresponding to this search query.

According to an embodiment of the present application, the second precondition could be: click-through rate is no less than a second threshold value, e.g., the second threshold value could be 50% or 75% of the average click-through rate for all search query categories.

According to an embodiment of the present application, when determining the highest need level category under an unclicked search query, one can pre-obtain the category list corresponding to the user's background. This category list can include all categories listed in greater-to-lesser order. In some embodiments, the category list includes information such as user-searched search queries extracted from logs, the search frequencies of search queries, merchandise information click frequencies and category click frequencies, as well as the frequencies of each of the categories, with all categories arranged in order from greater to lesser frequencies. In some embodiments, the frequency statistics for each of the categories are computed on the basis of three factors: the number of categories that satisfy a first precondition for a given search query, merchandise information click-through frequencies, and category click-through frequencies. Table 1 illustrates one example of the factors used to compute category frequencies.

TABLE 1

| Action | Statistical feature | Statistical method |
|---|---|---|
| Search query | Number of categories | Each time the search |
| | (denoted as n) satisfying | query is searched, add |
| | a first precondition | 1/n to category frequency |
| | under the search query | |
| Merchandise | Category to which the | Each time merchandise |
| information | merchandise information | information under the |
| click frequency | belongs | category is clicked once, |
| | | add 1 to category frequency |
| Category click | Category | Each time category is clicked, |
| frequency | | add 1 to category frequency |

An example of determining the highest need level category for an unclicked search query is described below.

For example, User Z input a search query, “apple.” This search query “apple” is a clicked search query (i.e., a category or merchandise information in response to the search query has previously been clicked by a user). Assume that a pre-determined category list corresponding to the user's background and this search query includes “mobile phone,” “MP3,” “women's apparel,” and “fruit.” Assuming that “mobile phone” does not satisfy a first precondition and is discarded, then the number of categories satisfying a first precondition and corresponding to the search query “apple” is 3. When computing the frequency of the category “MP3,” the system will consider the search frequency, merchandise information click frequency, and category click frequency of the search query. If, based on the information in the category list, for the search query “apple,” the search frequency of the category of “MP3” in response to this search query is 1,000, then add (⅓)*1000 to the frequency of the category “MP3.” If the click frequency of merchandise information under the category “MP3” is 100, then add 100 to the frequency of the category “MP3.” If the click frequency for the category “MP3” is 10, then add 10 to the frequency of the category “MP3.” Thus, according to the computation outlined in Table 1, the system acquires an “MP3” category frequency of (⅓)*1,000+1*100+1*10. The computation is repeated to determine the category frequencies for the categories of “women's apparel” and “fruit.”

In this example, the categories are sorted in order of greater to lesser frequency. For purposes of illustration, assume that the order for these three categories is: “MP3,” “fruit,” and “women's apparel.”

Assuming that User Z searched the search query “apple” only, the categories included in the category list corresponding to User Z's user background are: “MP3,” “fruit,” and “women's apparel.” User Z subsequently inputs the search query, “apple MP3.” If this search query is an unclicked search query (e.g., no user has previously clicked on a category or merchandise information in response to the search query), then the system can select a category “MP3” from the pre-obtained category list corresponding to the user background. If the click-through rate of this category “MP3” is not less than 75% of the average click-through rate of all categories for the search query “apple,” then it is determined that the category “MP3” has the highest need level. Otherwise, the system continues by selecting the second-highest-frequency category “fruit” and assesses whether the click-through frequency for the “fruit” category is less than 75% of the average click-through rate of all categories for the search query “apple.” If the click-through rate of the “fruit” category is not less than 75% of the average click-through rate of all categories for the search query “apple,” then the system can determine that the “fruit” category is the highest need level category. Otherwise, the system continues by selecting the category “women's apparel” and carrying out the subsequent assessment. If, after going through the entire category list, the system fails to find a category whose click-through rate is no less than 75% of the average click-through rate for all categories for the search query “apple,” then it is determined that there is no need to obtain the highest need level category corresponding to this search query “apple MP3.”

After completing step 308, control is returned to 304 to process the next search query. The process completes when all the search queries are completed, and the correspondences between user information and search queries, and respective highest need level categories are established.

In some embodiments, the correspondences between user information and search queries, and respective highest need level categories obtained through steps 302 through 308 described above are stored in a database. In some embodiments, the stored information is periodically updated so that the correspondences between user information and search queries, and respective highest need level categories can reflect the most recent personalized needs of the user.

Returning to FIG. 2, step 208 ranks merchandise information according to the highest need level category. In other words, merchandise information that belongs to highest need level category is listed higher in the results.

For example, assume that the highest need level category for a query keyword is the category “fruit.” Then, the system ranks higher merchandise information which belongs to the category “fruit.” Thus, the merchandise information under the “fruit” category can receive priority in being displayed to the user.

In some embodiments, the system, based on the obtained highest need level category, sets grades of the categories corresponding to all pieces of found merchandise information and, on the basis of the set category grades, obtains the user need values corresponding to all pieces of obtained merchandise information and then ranks all merchandise information according to user need values.

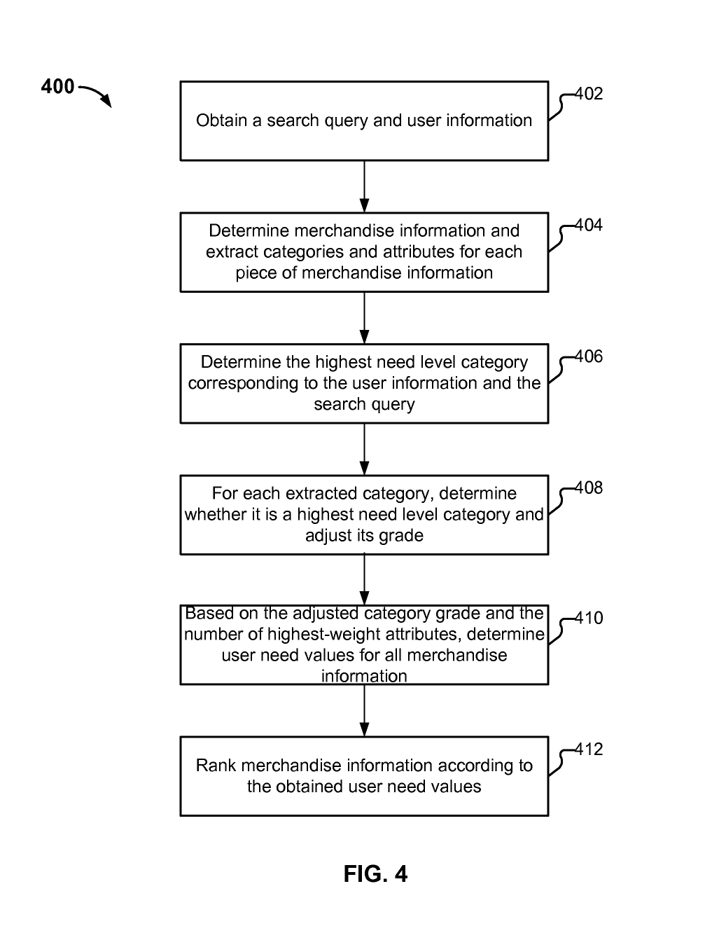

FIG. 4 is a flowchart illustrating another embodiment of a merchandise information ranking process. At 402, a search query and user information are obtained. In some embodiments, the search query is entered by the user via the client, and the corresponding user information is looked up in a preconfigured user database.

At 404, merchandise information corresponding to the search query is found, and the categories and attributes for each piece of merchandise information are extracted.

Attributes are used to describe the merchandise information. Every piece of merchandise information may have a number of attributes that correspond to it. For example, merchandise information concerning mobile phones may include attributes such as brand, standard, screen size, and so forth.

At 406, based on the correspondences between the user information and the search query, and the respective highest need level categories, determine the highest need level category corresponding to the user information and search query. Based on the category grading information and attribute grading information for the obtained merchandise information, look up the grade of the extracted category and the number of highest-weight attributes.

Merchandise information is ranked according to highest need level category. Specifically, at 408, for each extracted category, if it is a highest need level category, then adjust the grade of this category to the highest-weight grade. If it is not a highest need level category, then adjust the grade of this category to the second-highest-weight grade (which can be the second-highest-weight grade on an absolute scale or relative to other categories depending on implementation). At 410, based on the adjusted category grade and the number of highest-weight attributes, user need values for all merchandise information are obtained. At 412, merchandise information is ranked according to the obtained user need values.

In step 410, the system uses the adjusted category grades and the number of highest-weight attributes with user preference weights to calculate the user need values for all merchandise information. In some embodiments, user need values are calculated as follows:

V=W*α/C1+W*β*N1/Nw (2)

In formula (2) above, V represents user need value, W represents user preference weight, C1 represents category grade, N1 represents the number of attributes having the highest weight, Nw represents the total number of attributes, and α and β can be preset values less than 1 and greater than 0, with the sum of α and β equal to 1. For example, the value of a can be 0.8, and the value of β can be 0.2. W and the values of α and β can be determined based on actual circumstances, and are not limited to the numerical values given in the formula above. Nw is the total number of attributes extracted in step 404.

Once user need values for each piece of merchandise information are determined based on formula (2), the various pieces of merchandise information are ranked according to user need values.

In some embodiments, prior to 402, category grading information and attribute grading information is obtained based on the categories and attributes of merchandise information. This step can be carried out offline and does not need to be performed during a transaction. After obtaining the search query and user information, the online transaction system can directly search for the highest need level category corresponding to this user information and search query and rank merchandise information according to the highest need level category. This can increase data processing speed in the merchandise transaction process and improve the user's experience.

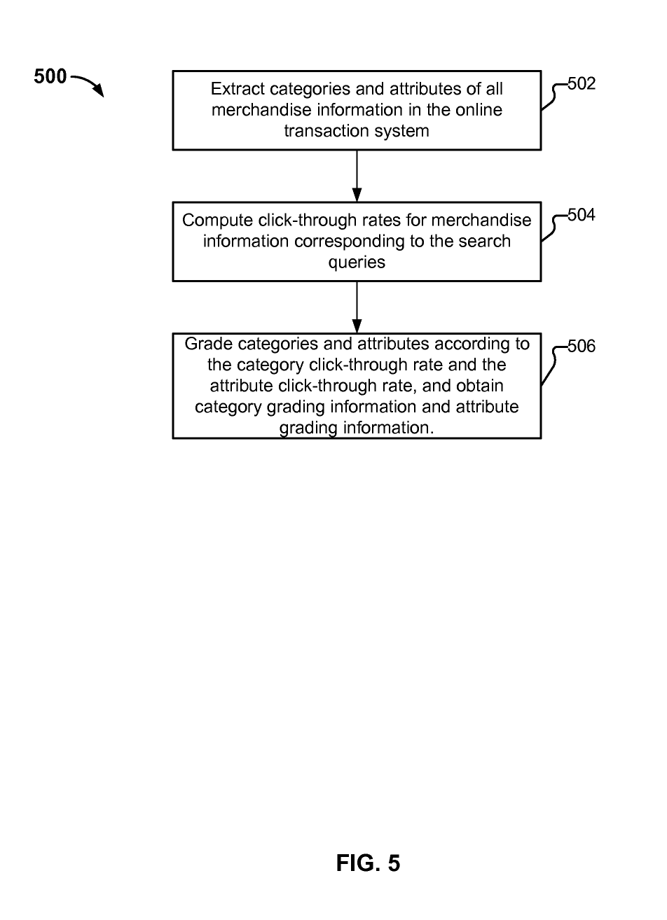

FIG. 5 is a flowchart illustrating an embodiment of a process for obtaining category grading information and attribute grading information.

At 502, categories and attributes of all merchandise information in the online transaction system are extracted.

At 504, based on the click logs and exposure logs of the online transaction system, click-through rates for merchandise information corresponding to search queries are computed.

At 506, take the click-through rate of the merchandise information as the category click-through rate and attribute click-through rate, grade categories and attributes according to the category click-through rate and the attribute click-through rate, and obtain category grading information and attribute grading information. The click-through rates for each piece of merchandise information were already calculated in step 504. Since each piece of merchandise information can be expressed in the form of a category and attribute set, the merchandise information click-through rate in step 506 can be taken as a category click-through rate and an attribute click-through rate. For example, assume that the category of a certain piece of merchandise information is M, and its attributes are N1, N2 . . . Nn. If a user clicks the merchandise information in the course of a given search, then category M and attributes N1, N2 . . . Nn corresponding to the merchandise information are all considered to have received clicks; if the user does not click said information, then the category and attributes corresponding to the merchandise information are deemed not to have received clicks.

In the embodiments of the present application, the aforesaid steps 502 and 504 may be executed in sequence or according to actual conditions. For example, they may be executed synchronously, or step 504 may be executed first, followed by step 502.

In this example, the search query in step 504 refers to user-input search queries previously received by the online transaction system during a predetermined period. The predetermined period may be determined based on actual conditions. For example, it may be one week, or it may be several months.

According to one embodiment, step 504 may also comprise: identifying and filtering data incapable of reflecting user need according to the click log and exposure log in said online transaction system. Wherein the exposure log records the number of times merchandise information is displayed to users, and the click log records the number of times merchandise information that has been displayed to users has been clicked. For example, if, through analysis of the click log and exposure log, it is discovered that in a given search all exposed merchandise information has been clicked, then this search action can be considered incapable of reflecting user need. Therefore, this search action is set as invalid, and the click data and exposure data related to this search action and recorded in the click log and exposure log are not used to compute the click-through rates for the merchandise information corresponding to the search query.

In step 506, the grading of categories and attributes according to category click-through rates and attribute click-through rates can include: grading categories according to category click-through rates and/or category traffic; and grading attributes according to attribute click-through rates and/or attribute traffic.

The category grading information and attribute grading information is acquired in step 506. Category grading information may include the grades of all categories and the specific categories corresponding to each grade. Table 2 illustrates the grading information of categories in some embodiments of the present application.

TABLE 2

| Category grade | Specific categories corresponding to each grade |
|---|---|
| Grade 1 | Category A1, Category A2, . . . |
| Grade 2 | Category B1, Category B2, . . . |
| Grade 3 | Category C1, Category C2, . . . |

For specifics on how grading is done, reference may be made to Table 3. Descriptive information on category grades of the present application is as shown in Table 3. The descriptive information for each grade serves to describe its criteria.

TABLE 3

| Category grade | Descriptive information |
|---|---|
| Grade 1 | High page view (PV) category or medium PV category, |
| | and with category click-through rate greater than the |
| | average category click-through rate for the search query |
| Grade 2 | High PV category and with category click-through rate |
| | greater than 75% of the average category click-through |
| | rate for the search query; or medium PV category and |
| | with category click-through rate greater than 90% of |
| | the average category click-through rate for the search |
| | query |
| Grade 3 | Low PV category; or, categories other than grade 1 or |
| | grade 2 |

Attribute grading information may include the grades of all attributes and the specific attributes corresponding to each grade. Table 4 presents an example of grading information for attributes according to embodiments of the present application.

TABLE 4

| Attribute grade | Specific attributes corresponding to each grade |
|---|---|
| Grade 1 | Attribute D1, attribute D2, . . . |
| Grade 0 | Attribute E1, attribute E2, . . . |

For specifics on how grading is performed, reference may be made to Table 5. Examples of attribute grade description information in the present application are shown in Table 5. The description information for each grade is used to describe its criteria.

| Attribute grade | Descriptive information |
|---|---|
| Grade 1 | Click-through rate of attributes under the category |
| | is greater than average attribute click-through rate |
| | for the search query |
| Grade 0 | Click-through rate of attributes under the category |
| | is less than average attribute click-through rate |
| | for the search query |

In Table 3, a high PV category refers to a category for which traffic exceeds a third threshold value within a predefined period of time. The third threshold value may be set at 10% of the threshold value of total traffic of all categories corresponding to the search query, or it may be set as a fixed number of times, e.g., 100 times or 200 times. The predefined time period may be two weeks, or it may be any other appropriate length of time, which can be determined according to the actual conditions of data processing.

A low PV category refers to a category for which traffic is below a fourth threshold value within a set period of time. The fourth threshold value may be set as 1% of the total traffic of all categories corresponding to the search query, or it may be set as a fixed number of times, e.g., 5 times.

A medium PV category refers to a category for which traffic falls between a third threshold value and a fourth threshold value within a set period of time, i.e., one that is neither a high PV category nor a low PV category.

Table 1, Table 2, Table 3, Table 4, and Table 5 are merely example tables provided by the present application. Persons with ordinary skill in the art may make various modifications or substitutions according to actual conditions. For example, in the category grade descriptive information, one may use the average category click-through rate for a search query as the sole criterion for determining the grade, without using category traffic as a criterion for determining the grade; or category traffic alone may be used as the criterion to determine the grade. Or, for example, when the average category click-through rate for a search query is used as the criterion for determining the grade of a category, other data capable of performing the same function as that of the average category click-through rate for a search query may also be used as criteria for determining the grade of the category. Or, for example, when the average category click-through rate for a search query is used as the criterion for determining the grade of a category, numerical values other than 75% and 90% shown in Table 3 may be used. In the attribute grade descriptive information, the average attribute click-through rate for a search query may be used as the sole criterion for determining the grade, without using attribute traffic as a criterion for determining the grade. Moreover, attribute traffic may be used as the sole criterion for determining the grade, without using the average attribute click-through rate for the search query as the criterion for determining the grade; or attribute traffic and the average attribute click-through rate for the search query both can be used as the criteria for determining the grade.

In Table 2, Grade 1 is the grade with the highest weight, Grade 2 is the grade with the second-highest weight, and Grade 3 has the lowest weight. In Table 4, Grade 1 is the grade with the highest weight, and Grade 0 is the grade with the next weight. Of course, the embodiments of the present application are illustrative only. In specific applications, the defined grades can be adjusted according to actual circumstances. If the category grading information and attribute grading information obtained in advance include a greater number of grades, the weight of each grade can be set according to actual circumstances.

Process 500 of FIG. 5 described above are for all users in the online transaction system. The obtained click logs, exposure logs, category click-through rates, attribute click-through rates, category grading information, and attribute grading information reflect the needs of the general public. The above do not reflect the needs of an individual user. Process 300 of FIG. 3 is for a single user. The obtained correspondences between user information and search queries, and respective highest need level categories reflect the need types of a single user.

A specific example is used below to explain how merchandise information is ranked according to the obtained highest need level category.

For example, a user with user ID I3 inputs the search query “apple.” The online transaction system receives “I3” and the search query “apple” as input by the user, searches for merchandise information corresponding to the search query “apple,” and extracts the categories and attributes of the merchandise information. For example, the extracted categories include: “fruit,” “women's apparel,” and “MP3.”

The online transaction system obtains the highest need level category corresponding to I3 and the search query “apple” in accordance with pre-obtained user information, search queries, and highest need level categories. For example, in the case of this particular user, the highest need level category is “fruit.”

In addition, the online transaction system can, in accordance with pre-obtained category grading information and attribute grading information for merchandise information, look up the grades belonging to the three categories “fruit,” “women's apparel,” and “MP3.” In addition, it can look up the grades belonging to the extracted attributes. For example, the grade for the “fruit” category is Grade 3, the grade for the “women's apparel” category is Grade 2, and the grade for the “MP3” category is Grade 1. The grades of all extracted attributes can be similarly looked up, and the number of highest-weight attributes can be looked up, as can the total number of extracted attributes.

Since the “fruit” category is the highest need level category, the grade for the “fruit” category can be adjusted to the highest-weight grade, i.e., Grade 1.

The two categories “women's apparel” and “MP3” do not have the highest need level grade. Thus, the grade for these two categories can be adjusted to the second-highest-weight grade, i.e., Grade 2.

User need values can be obtained for each piece of merchandise information using Formula (2).

When calculating the merchandise information-based user value under the “fruit” category, the value of C1 in Formula (2) may be set at 1 since the grade for the “fruit” category has already been adjusted to the highest-weight grade.

When calculating the merchandise information user value under the “women's apparel” and “MP3” categories, the value of C1 in Formula (2) may be set at 2 since the grade for the “women's apparel” and “MP3” categories has already been adjusted to the second-highest-weight grade.

It needs to be explained here that the above-described adjustments to the grades of the various categories are for determining the values of the grades of all the currently extracted categories when performing calculations with Formula (2), and are not for adjusting category grading information obtained offline.

After using Formula (2) to calculate user values for all pieces of merchandise information, the system can rank merchandise information according to user values. For example, the system can first grade merchandise information according to textual correlations and then make intra-grade adjustments based on user values to merchandise information rankings within each grade. When adjusting merchandise information rankings within each grade, it can also incorporate market factors.

In the embodiment shown in FIG. 2, the system looks up the extracted category grades and numbers of highest-weight attributes in accordance with the obtained category grading information and attribute grading information for merchandise information and adjusts the grades of all the extracted categories in accordance with the obtained highest need level categories. As a result, the adjusted category grades reflect the personalized needs of specific users. Then, on the basis of the adjusted category grades and the number of highest-weight attributes, the system obtains user values for all merchandise information. As can be seen from Formula (2), if the category grade is set at the highest-weight, then the calculated user value will also be high. When merchandise information is being ranked according to user need value, merchandise information with high user need values can be ranked in front. In this way, the ranking of merchandise information can reflect the personalized needs of specific users, with the result that the merchandise information corresponding to the highest need level category can be ranked towards the front, which enables users to find merchandise information that meets their needs. Thus, this approach can improve the traffic quality of the online transaction system, increase click-through rates, and enhance user experience. In addition, since merchandise information can reflect the personalized needs of users, users need not send large volumes of useless query requests through the client end to the server. As a result, this approach reduces operating pressures on the server and increases server response speed.

The present application provides a further embodiment, wherein merchandise information can be ranked by setting individualized feature weights.

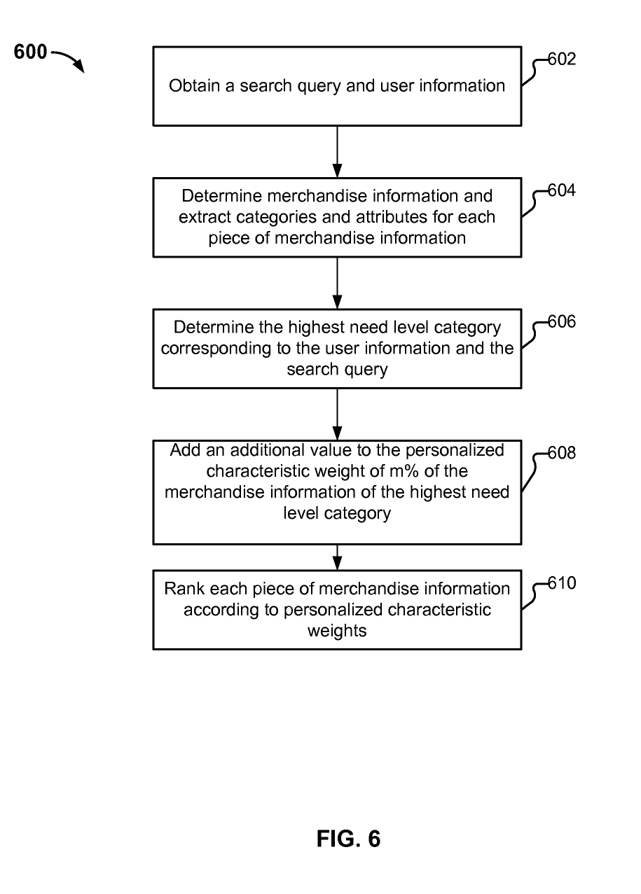

FIG. 6 is a flow chart illustrating another embodiment of a merchandise information ranking process.

At 602, a search query and user information are obtained.

At 604, merchandise information corresponding to the search query is determined, and categories and attributes for each piece of merchandise information are extracted.

At 606, based on the correspondences of the obtained user information and search queries with respective highest need level categories, the highest need level category corresponding to the user information and search query is determined.

At 608-610, merchandise information according to the highest need level categories is ranked. Specifically, at 608, an additional value is added to the personalized characteristic weight of m % of the merchandise information of the highest need level category. In this example, m is a constant with a value greater than 0 and less than 100. For example, m % could be 75%.

The personalized characteristic weight of 1−m % of the merchandise information of the category which is the highest need level category can remain unchanged. The personalized characteristic weight is a parameter of the personalized characteristics of each piece of merchandise information. A personalized characteristic weight can be set for each piece of merchandise information. In the case of merchandise information for categories which are highest need level categories, a value can be added to the personalized characteristic weights for a part of this merchandise information. For example, if the preset personalized characteristic weight of each piece of merchandise information is Q, and the additional value is P, then the personalized characteristic weight for a part of the merchandise information of the categories which are the highest need level categories is set at Q+P, while the personalized characteristic weight for the rest of the merchandise information of the categories which are the highest need level categories remains Q.

At 610, each piece of merchandise information is ranked according to personalized characteristic weights.

Specifically, the system can rank each piece of merchandise information in light of user preference weights and other weights. For example, the system can add user preference weights to personalized characteristic weights for each piece of merchandise information to acquire comprehensive weights for each piece of merchandise information. The pieces of merchandise information are ranked according to comprehensive weights.

Adding an additional value to the personalized characteristic weight of m % of the merchandise information of the category which is the highest need level category (step 608) avoids a situation where only merchandise information under highest need level categories is exposed. It can subject all merchandise information under various categories to a certain probability of exposure. In addition, the ranking results can be made more reasonable through adjusting m.

In all the embodiments described above, the online transaction system can, when it finds the highest need level category based on a user's information and search query, cache the ranked merchandise information and establish a correspondence between the search query and the highest need level category on the one hand and ranked information on the other.

If the highest need level category obtained on the basis of the search query and another user's information are the same as the cached highest need level category, then the system can display ranked merchandise information corresponding to the cached search query and need level to the other user.

Because user information is diverse and highest need level categories are simpler, the caching of ranked merchandise information enables rapid processing of subsequent user query requests. This in turn increases data processing speed and improves the user's experience.

For example, the highest need level category corresponding to information for 100 users might include 10. In other words, an average of 10 users might correspond to the same highest need level category. Assuming that User A and User B input the Search Query b, and the located corresponding highest need level category is in both cases Category a, the need level which the online transaction system is going to find on the basis of User A's information and Search Query b is going to be Category a. In addition, the merchandise information will be ranked according to Category a. Subsequently, the highest need level category that the online transaction system finds on the basis of User B's user information and Search Query b will also be Category a. Thus, the online transaction system can directly display to User B the ranked merchandise information corresponding to Search Query b that was previously cached without having to re-rank merchandise information according to the highest need level category.

The methods provided by all the embodiments of the present application can be achieved using C++ and can run on a Linux system.

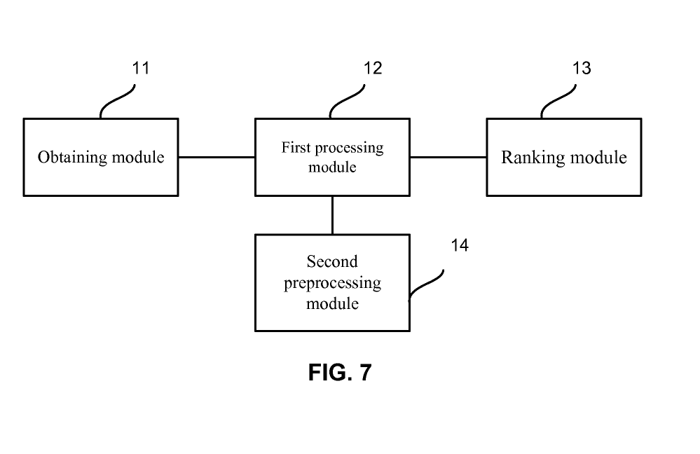

FIG. 7 is a system diagram illustrating a first embodiment of a search results ranking device of the present application. This device comprises: an obtaining module 11, a processing module 12, and a ranking module 13. Obtaining module 11 is for obtaining search queries and user information. First processing module 12, which is connected to obtaining module 11, is for finding merchandise information corresponding to a search query and for obtaining, based on the obtained correspondences between user information and search query on the one hand and highest need level categories on the other, highest need level categories corresponding to user information and search queries. Ranking module 13, which is connected to processing module 12, is for ranking merchandise information according to highest need level categories.

The device as shown in FIG. 7 can also comprise a second preprocessing module 14. This second preprocessing module 14, which is connected to first processing module 12, is for obtaining correspondences between user information and search query, and respective highest need level categories based on logs in the online transaction system.

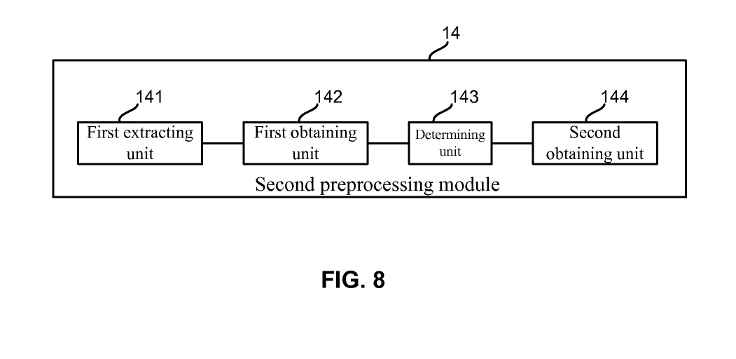

FIG. 8 is a structural diagram illustrating an embodiment of the second preprocessing module 14 in FIG. 7. This preprocessing module 14 comprises a first extracting unit 141, a first obtaining unit 142, a determining unit 143, and a second obtaining unit 144. First extracting unit 141 is for extracting logs corresponding to user information. First obtaining unit 142, which is connected to first extracting unit 141, is for obtaining, based on the log corresponding to user information, categories satisfying a first precondition and corresponding to the search query. Determining unit 143, which is connected to first obtaining unit 142, is for determining, based on the category exposure of the category having the largest exposure among the categories satisfying a first precondition, whether said search query is a single-need search query or a multi-need search query. Second obtaining unit 144, which is connected to determining unit 143 and processing module 12 of FIG.7, is for determining the highest need level category among categories satisfying a first precondition when determining unit 143 determines whether the search query is a single-need search query or a multi-need search query and for establishing correspondences between user information and search query with highest need level categories.

Determining unit 143 is specifically for determining, if the category exposure of the category having the largest exposure of all the categories satisfying a first precondition is greater than a threshold value, that the search query is a single-need search query; and determining, if the category exposure of the category having the largest exposure of all the categories satisfying a first precondition is less than or equal to a threshold value, that the search query is a multi-need search query.

Second obtaining unit 144 is specifically for: obtaining from a log the merchandise information click frequency and category click frequency for the selected category if the search query is a multi-need search query and a clicked search query: obtaining, based on the merchandise information click frequency and category click frequency for the selected category, the need values of the categories satisfying a first precondition, for determining the need values of categories satisfying a first precondition, for taking the highest need value categories as highest need level categories, and for thereby obtaining correspondences between user information and search queries with respective highest need level categories.

Alternatively, second obtaining unit 144 is specifically for: selecting, from a pre-obtained category list corresponding to user industry background, the category having the highest frequency if the search query is a multi-need and unclicked search query and for assessing whether the click-through rate of the highest-frequency category satisfies a second precondition; selecting, if the click-through rate of the highest-frequency category does not satisfy a second precondition, the category having the second-highest frequency and assessing whether the click-through rate of the second-highest-frequency category satisfies a second precondition, and so on until the category whose category click-through rate satisfies a second precondition is found, and taking the category whose category click-through rate satisfies a second precondition as the highest need level category and thereby obtaining the correspondences between user information and search queries with respective highest need level categories.

According to an embodiment, ranking module 13 can specifically be used for ranking closest to the front that merchandise information which belongs to the highest need level category.

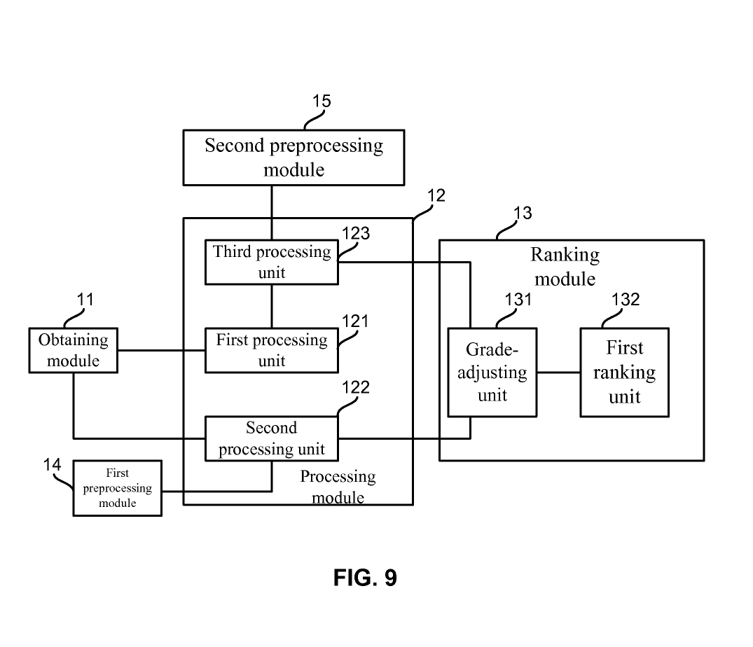

FIG. 9 is a structural diagram illustrating another embodiment of a search results ranking device of the present application. The device shown for this embodiment further comprises a second preprocessing module 15. Second preprocessing module 15 is for obtaining category grading information and attribute grading information.

Processing module 12 can comprise a first processing unit 121, a second processing unit 122, and a third processing unit 123. First processing unit 121, which is connected to obtaining module 11, is for finding merchandise information corresponding to search queries. Second processing unit 122, which is connected to obtaining module 11 and preprocessing module 14, is for obtaining, based on the correspondences between user information and search queries, and respective highest need level categories obtained by first preprocessing module 14, the highest need level categories corresponding to user information and search queries. Third processing unit 123, which is connected to first processing unit 121 and second preprocessing module 15, is for extracting categories and attributes based on merchandise information after acquiring merchandise information corresponding to the search query and looking up, based on the category grading information and attribute grading information of the merchandise information obtained by second processing module 15, the extracted category grades and number of highest-weight attributes.

Ranking module 13 can comprise a grade-adjusting unit 131 and a first ranking unit 132. Grade-adjusting unit 131, which is connected to third processing unit 123 and second processing unit 122, is for adjusting the grade of the extracted category to the highest-weight grade if the category extracted by third processing unit 123 is the highest need level category obtained by second processing unit 122 and for adjusting the grade of the extracted category to the second-highest-weight grade if the category extracted by third processing unit 123 is not the highest need level category obtained by second processing unit 122. First ranking unit 132, which is connected to grade-adjusting unit 131, is for obtaining merchandise information user need values based on the category grade adjusted by grade-adjusting unit 131 and the looked-up number of highest-weight attributes; and for ranking said merchandise information according to the obtained user need values.

Specifically, first ranking unit 132 can be for integrating the adjusted category grades and the looked up number of highest-weight attributes with user preference weights, and calculating the user need values of the merchandise information; and for ranking merchandise information according to the obtained user need values.

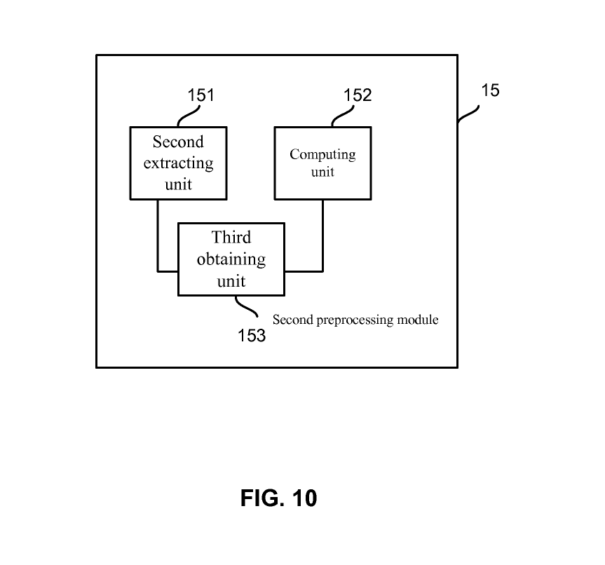

FIG. 10 is a structural diagram illustrating an embodiment of the second preprocessing module in FIG. 9. Second preprocessing module 15 can comprise a second extracting unit 151, a computing unit 152, and a third extracting unit 153. Second extracting unit 151 is for extracting the categories and attributes of all merchandise information in the online transaction system. Computing unit 152 is for computing, based on the click log and exposure log in the online transaction system, the click-through rates for merchandise information corresponding to the search queries. Third obtaining unit 153, which is connected to second extracting unit 151, computing unit 152, and third processing unit 123 of FIG. 9, is for taking the click-through rates of merchandise information as category click-through rates and attribute click-through rates, grading categories and attributes according to category click-through rates and attribute click-through rates, and obtaining category grading information and attribute grading information.

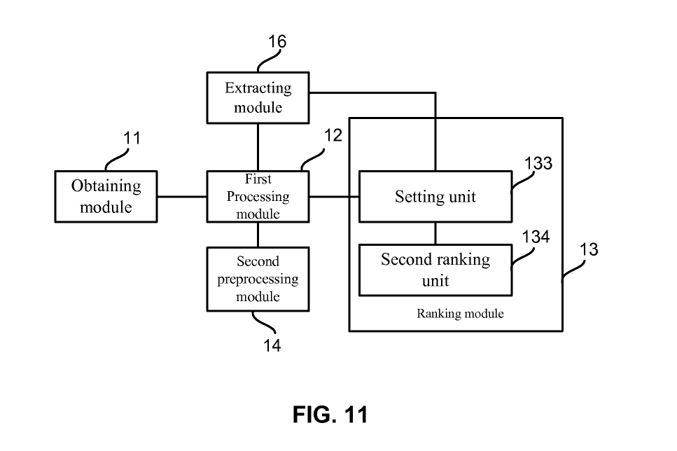

FIG. 11 is a structural diagram of another embodiment of a search results ranking device of the present application. This device comprises an obtaining module 11, a first processing module 12, a ranking module 13, a second preprocessing module 14, and an extracting module 16. Extracting module 16, which is connected to first processing module 12, is for extracting merchandise information categories after first processing module 12 finds merchandise information corresponding to the search query.

In this embodiment, ranking module 13 can comprise a setting unit 133 and a second ranking unit 134. Setting unit 133, which is connected to extracting module 16 and processing module 12, is for adding an additional value to the personalized characteristic weight of m % of the merchandise information of the category which is the highest need level category. Second ranking unit 134, which is connected to setting unit 133, is for ranking all merchandise information according to personalized characteristic weights.

The devices provided by the various embodiments described in the present application can also comprise a caching module. This caching module, which can be connected to a ranking module, is for caching ranked merchandise information and establishing correspondences between search queries and highest need level categories, with respective ranked merchandise information.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

For the specific operating processes of the various modules in the devices offered by the present application, see the descriptions in the method embodiments section.

The query results ranking devices offered by the present application may be equipment within the online transaction system. For example, it may be a server. The query results ranking methods offered by the present application may be realized through applications on a server.

In the search results ranking devices offered by the present application, the ranking module ranks merchandise information based on the obtained highest need level categories. These highest need level categories correspond to user information. Thus, merchandise information can embody the personalized needs of users. Search results corresponding to highest need level categories can be ranked towards the front, enabling users to quickly find the merchandise information they need. This can improve the traffic quality of the online transaction system, increase click-through rates, and enhance the user's experience. In addition, since the merchandise information can embody the user's personalized needs, the user need not send large volumes of useless query requests through the client end to the server. As a result, this scheme reduces operating pressures on the server and increases server response speed.

Moreover, such a ranking method helps with the effective allocation of market resources. It can provide sellers whose products are in high demand with more opportunities to display information and thus raise click-through rates.

The query results ranking devices offered by the present application may be equipment within the online transaction system. For example, it may be a server. The query results ranking methods offered by the present application may be realized through applications on the server.

Although the present application has already been described with reference to typical embodiments, it should be understood that the terms used are descriptive and illustrative and are not restrictive terms. Because the present application can be specifically implemented in a variety of forms without departing from the spirit or substance of the invention, it should be understood that the aforesaid embodiments are not limited to any of the details above, but should be broadly interpreted within the spirit and scope defined in the attached claims. Therefore, all variations and modifications falling within scope of the claims or their equivalent should be covered by the attached claims.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for providing query results, comprising:
one or more processors configured to:
obtain a search query comprising one or more query words sent by a user;
obtain user information that corresponds to the user;
determine merchandise information that corresponds to the search query;
based on correspondence information of previously stored user information and previously stored search queries with respective highest need level categories, determine a highest need level category that corresponds to the received user information and obtained search query, wherein the highest need level category is a category determined to best reflect the user's individual need for merchandise information in response to the search query; and
rank the merchandise information at least in part according to the determined highest need level category; and
one or more memories coupled to the one or more processors, configured to provide the one or more processors with instructions.

2. The system of claim 1, wherein the correspondence information of previously stored user information and previously stored search queries with respective highest need level categories is determined based on log information recorded by the online transaction system.

3. The system of claim 1, wherein the correspondence information of previously stored user information and previously stored search queries with respective highest need level categories is determined by:
obtaining log information of user activities; and
for each search query included in the log information:
obtaining, based on the log information, categories satisfying a first precondition and corresponding to said each search query;
determining, based on a category exposure of a category having the largest exposure among the categories satisfying the first precondition, whether said each search query is a single-need search query or a multi-need search query;
in the event that said each search query is a multi-need search query, determining the highest need level category among the categories satisfying the first precondition; and
establishing a correspondence between the user information and said each search query with the highest need level category among the categories satisfying the first precondition.

4. The system of claim 3, wherein determining whether said each search query is a single-need search query or a multi-need search query includes:
in the event that the category exposure of the category having the largest exposure of the categories satisfying the first precondition is greater than a threshold value, determining that said each search query is a single-need search query; and
in the event that the category exposure of the category having the largest exposure of all the categories satisfying the first precondition is less than or equal to a threshold value, determining that said each search query is a multi-need search query.

5. The system of claim 4, wherein determining the highest need level category among is categories that satisfy the first precondition comprises:
in the event that said each search query is a clicked search query:
obtaining from the log information, merchandise information click frequencies and category click frequencies of the categories that satisfy the first precondition;
obtaining, based on the merchandise information click frequencies and category click frequencies of the categories that satisfy the first precondition, need values of the categories satisfying the first precondition; and
determining the category having the highest need value among the categories satisfying the first precondition as the highest need level category;
in the event that said each search query is an unclicked search query:
selecting from a pre-obtained category list corresponding to user background a category having the highest frequency; and
determining whether a click-through rate of the selected category having the highest frequency satisfies a second precondition.

6. The system of claim 1, wherein merchandise information that belongs to the highest need level category receives higher ranking

7. The system of claim 1, wherein the one or more processors are further configured to:
extract categories and attributes associated with the merchandise information; and
look up, based on the extracted categories and attributes, grades of the extracted categories and numbers of most highly weighted attributes.

8. The system of claim 7, wherein ranking the merchandise information at least in part according to the determined highest need level category comprises:
in the event that an extracted category is a highest need level category, adjusting a corresponding grade of the extracted category to a highest weight grade;
in the event that the extracted category is not a highest need level category, adjusting the corresponding grade of the extracted category to a second-highest weight grade;
determining, based on the adjusted category grades and the looked up number of highest weight attributes, user need values for the merchandise information; and
ranking the merchandise information based at least in part on the user need values.

9. The system of claim 7, wherein the one or more processors are further configured to determine, based on the categories and attributes of said merchandise information in the online transaction system, category grading information and attribute grading information.

10. The system of claim 8, wherein determining the category grading information and the attribute grading information comprises:
extracting categories and attributes of all merchandise information in the online transaction system;
computing, based on log information, click-through rates for merchandise information corresponding to the search query; and
using the click-through rate of the merchandise information as category click-through rate and attribute click-through rate of the merchandise information, grading the categories and attributes based on the category click-through rates and attribute click-through rates to obtain the category grading information and attribute grading information.

11. The system of claim 10, wherein the one or more processors are further configured to:
combine the adjusted category grades and the number of highest weight attributes with user preference weights to calculate the user need values.

12. The system of claim 1, wherein:
the one or more processors are further configured to extract categories based on the merchandise information; and
ranking the merchandise information at least in part according to the determined highest need level category comprises:
adding an additional value to a personalized characteristic weight of m % of the merchandise information of the highest need level category, m being a constant with a value greater than 0 and less than 100; and
ranking the merchandise information according to personalized characteristic weights.

13. The system of claim 1, the one or more processors are further configured to cache ranked merchandise information.

14. The system of claim 13, wherein the search query is a first search query and the user information is a first user information, and the one or more processors are further configured to:
obtain a second search query from a second user and second user information; and
in the event that a highest need level category corresponding to the second search query and the second user information matches the highest need level category corresponding to the first search query and the first user information, and the second search query matches the first search query, send the ranked merchandise information that is cached to be displayed to the second user.

15. A method for providing query results, comprising:
receiving a search query sent by a user;
obtaining user information that corresponds to the user;
determining, at an online transaction system, merchandise information that corresponds to the search query;
based on correspondence information of previously stored user information and previously stored search queries with respective highest need level categories, determining a highest need level category that corresponds to the received user information and obtained search query, wherein the highest need level category is a category determined to best reflect the user's individual need for merchandise information in response to the search query; and
ranking the merchandise information at least in part according to the determined highest need level category.

16. The method of claim 15, wherein the correspondence information of previously stored user information and previously stored search queries with respective highest need level categories is determined based on log information recorded by the online transaction system.

17. The method of claim 15, wherein the correspondence information of previously stored user information and previously stored search queries with respective highest need level categories is determined by:
obtaining log information of user activities; and
for each search query included in the log information:
obtaining, based on the log information, categories satisfying a first precondition and corresponding to said each search query;
determining, based on a category exposure of a category having the largest exposure among the categories satisfying the first precondition, whether said each search query is a single-need search query or a multi-need search query;
in the event that said each search query is a multi-need search query, determining the highest need level category among the categories satisfying the first precondition; and
establishing a correspondence between the user information and said each search query with the highest need level category among the categories satisfying the first precondition.

18. The method of claim 15, wherein merchandise information that belongs to the highest need level category receives higher ranking

19. The method of claim 15, further comprising:
extracting categories and attributes associated with the merchandise information; and
looking up, based on the extracted categories and attributes, grades of the extracted categories and numbers of most highly weighted attributes.

20. A computer program product for providing query results, the computer program product being embodied in a tangible non-transitory computer readable storage medium and comprising computer instructions for:
receiving a search query sent by a user;
obtaining user information that corresponds to the user;
determining, at an online transaction system, merchandise information that corresponds to the search query;
based on correspondence information of previously stored user information and previously stored search queries with respective highest need level categories, determining a highest need level category that corresponds to the received user information and obtained search query, wherein the highest need level category is a category determined to best reflect the user's individual need for merchandise information in response to the search query; and
ranking the merchandise information at least in part according to the determined highest need level category.
